(19) United States
(12) Patent Application Publication
(10) Pub. No.: US 2024/0318742 A1
(43) Pub. Date: Sep. 26, 2024

(54) Shape Memory Alloy Actuator for Controlling a Valve Positioner with Pneumatic Output

(71) Applicant: ABB Schweiz AG, Baden (CH)

(72) Inventors: Sebastian Breisch, Neckarsteinach (DE); Arda Tueysuez, Darmstadt (DE); Ondrej Frantisek, Heddesheim (DE)

(73) Assignee: ABB Schweiz AG, Baden (CH)

(21) Appl. No.: 18/736,781

(22) Filed: Jun. 7, 2024

Related U.S. Application Data
(63) Continuation of application No. PCT/EP2021/085311, filed on Dec. 10, 2021.

(51) Int. Cl. F16K 31/40

(52) U.S. Cl. CPC F16K 31/40

(57) ABSTRACT

A positioner drive for controlling a pneumatic positioner, is described with a shape memory alloy actuation element, wherein the shape memory alloy actuation element is configured to be mechanically coupled to a valve of the valve positioner with pneumatic output for controlling the pneumatic positioner.

### CROSS-REFERENCE TO RELATED APPLICATIONS

The instant application claims priority to International Patent Application No. PCT/EP2021/085311, filed Dec. 10, 2021, which is incorporated herein in its entirety by reference.

### FIELD OF THE DISCLOSURE

The instant disclosure generally relates to actuators for industrial applications and, more specifically, to pneumatic actuators.

### BACKGROUND OF THE INVENTION

Today more than 60% of all actuators for the process industry are based on pneumatics, which require a positioner to control the position of the actuator. To operate such valve positioner a “main stage” of the positioner is driven by a “pilot stage”. The main stage is a unit that operates the actuator operating the process valve at the required pneumatic operation pressure, for example, 10 bar. The standard approach is to design the system, including the positioner, the actuator and the process valve such that an operating point of the main stage is close to a balance of forces, leading small changes on a control pressure to provide the desired tripping of the valve. Positioners in general must comply with stringent requirements on low energy consumption. The unit that controls the control pressure, the “pilot stage”, represents the controllable part of the system. A pressure to run the pilot stage is a fraction of the pneumatic operation pressure of the actuator and is provided by a pressure reducer.

Former power requirements have led to the design of a balanced main stage and a controllable sub-unit (pilot stage) that is to control a fraction of the pneumatic pressure. However, such design of a balanced main stage and a controllable pilot stage has a disadvantage that a constant blow-off is required in pilot stages. Thus, the usage of pilot stages make the system in general inefficient and cost intensive.

### BRIEF SUMMARY OF THE INVENTION

A pneumatic positioner, respectively a system including valve positioners with pneumatic output, faces two contrary business demands. On the one hand, there is a demand for high pneumatic pressure to operate the pneumatic actuator; on the other hand, there are stringent requirements for a low power consumption of the overall system. For this, a conventional positioner includes several submodules. These submodules can be seen as force amplifiers. However, this state-of-the-art arrangement leads to a complex and bulky setup. In order to operate high pneumatic pressure with low, particularly electrical, power, a close to equilibrium topology is applied, in which the forces by the pneumatic pressure are balanced by e.g. compensation springs. Thus, only a small force, and correspondingly energy, is sufficient to control a position of the process valve.

This small amount of “controlled force” is conventionally also based on pneumatic pressure. Therefore, a “pressure reducer” is used, which reduces the total pneumatic pressure partly to provide low-pressure to a subsystem, which is configured to be controlled with low electrical power. This “low-pressure-subsystem”, is the “pilot stage”. Using other words, the pilot stage acts as a force amplifier, controlling a larger force of a pneumatic pressure by a smaller controlled force. The usage of pilot stages in general is inefficient and cost intensive. Former power requirements have led to the design of a balanced main stage and a controllable sub-unit (pilot stage) that is to control a fraction of the pneumatic pressure.

State of the art systems of valve positioners with pneumatic outputs operated using such a pilot stage, which can be configured in different ways and are based on different technologies, as e.g. based on a piezo-nozzle or a flapper-nozzle. The usage of pilot stages in general leads to a bulky design and is cost intensive. A further problem using a pilot stage designs for valve positioners is a constant blow-off of the pneumatic medium, which results in inefficiency.

### BRIEF DESCRIPTION OF THE SEVERAL VIEWS OF THE DRAWING(S)

The accompanying drawings, which are included to provide a further understanding of the invention and are incorporated in and constitute a part of this application, illustrate embodiments of the invention and together with the description serve to explain the principle of the invention.

FIG. 1 is a diagram of a system for controlling a process valve in accordance with the disclosure.

FIG. 2a is a cross section through a state-of-the-art valve positioner with pneumatic output including sealing membranes.

FIG. 2b is a schematic diagram of a state-of-the-art balanced valve design.

FIG. 3a is a diagram of a valve positioner with pneumatic output with an external positioner drive in accordance with the disclosure.

FIG. 3b is a diagram of a valve positioner with pneumatic output including an internal positioner drive in accordance with the disclosure.

FIGS. 4a, 4b, and 4c are diagrams of a valve positioner with pneumatic output with an external shape memory alloy actuation element and resetting element in accordance with the disclosure.

FIGS. 5a and 5b are diagrams of a valve positioner with pneumatic output including a shape memory alloy actuation element and resetting element in accordance with the disclosure.

FIG. 6 is a circuit schematic of a shape memory alloy actuation element in accordance with the disclosure.

FIG. 7a is a schematic sketch of a 3/3 direction positioner valve in accordance with the disclosure.

FIG. 7b is a schematic sketch of a block diagram of 3/3 direction positioner valve in accordance with the disclosure.

FIG. 8a is a schematic sketch of a 4/3 direction positioner valve in accordance with the disclosure.

FIG. 8b is a schematic sketch of a block diagram of 4/3 direction positioner valve in accordance with the disclosure.

FIGS. 9a, 9b, and 9c are schematic sketches of a block diagram of 4/3 direction positioner valve with double actuation of a pneumatic actuator in accordance with the disclosure.

### DETAILED DESCRIPTION OF THE INVENTION

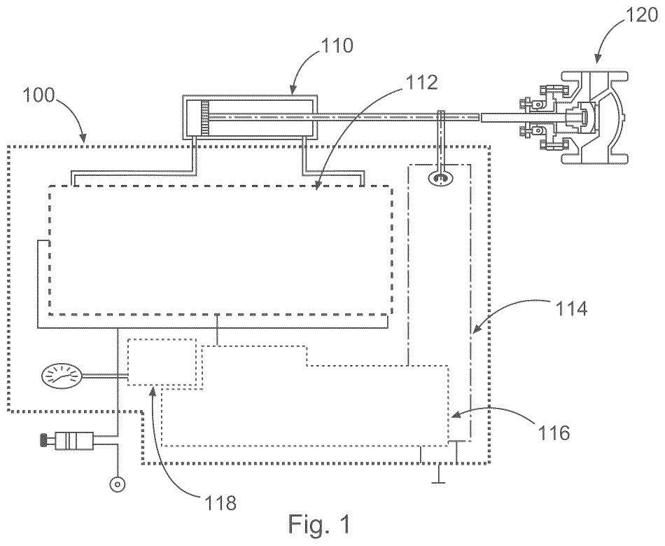

FIG. 1 sketches schematically an overall topology of a system to control a process valve 120 according to the state of the art, which is operated by a pneumatic actuator 110 to control a position of the pneumatic actuator 110, and wherein the pneumatic actuator 110 is controlled by a system including valve positioners with pneumatic output 100. The pneumatic actuator 110 can be operated in two different ways. In the way of single actuation, only one side of the pneumatic actuator 110 is controlled by valve positioners with pneumatic output 100 while the other side is moved by the aid of a compression spring, i.e., the pneumatic pressure is acting against a passive element. In the way of double actuation, both sides of the pneumatic actuator 110 are controlled by valve positioners with pneumatic output 100. Thus, full controllability of the process valve 120 can be achieved by double actuation.

For operation of such a system of valve positioners with pneumatic output 100 it includes a “main stage” 112 and a “pilot stage” 116. The main stage 112 is configured to operate the pneumatic actuator 110, which is coupled to the process valve 120 at a required pneumatic operation pressure, as e.g. 10 bars. The main stage 112 can be configured to have one operating point close to a force balance, such that only small changes using a control pressure can lead to the desired tripping of the process valve 120. The main stage 112, respectively valve positioners of the main stage 112, can include components to provide the close-to-force-balance operation to enable the force balance.

This small amount of “controlled force” is conventionally as well based on pneumatic pressure. Therefore, a “pressure reducer” 118 is used, which reduces the total pneumatic pressure partly to a low-pressure subsystem, which can then be controlled with low electrical power. The reduced pressure for operating the pilot stage 116 is a fraction of the pneumatic operation pressure and adjusted by the pressure reducer 118.

The pilot stage 116 represents a “low-pressure-subsystem” of the system including valve positioners with pneumatic output 100 and is configured to control the control pressure, which can be controlled by electrical signals generated by electronics 114. Using other words, the pilot stage 116 acts as a force amplifier, controlling a larger force of a pneumatic pressure by a smaller controlled force.

Typically, systems of valve positioners with pneumatic output 100 are operated via a pilot stage 116, which can be realized in different ways and by using different technologies, as e.g. using a piezo- or a flapper-nozzle.

In general, a valve positioner with pneumatic output 100, respectively a system of valve positioners with pneumatic output 100, faces two contrary demands for industrial production: On the one hand, there is a demand for high pneumatic pressure to operate; on the other hand, there are stringent requirements for a low power consumption.

To realize this, a conventional system of valve positioners with pneumatic output 100 as shown in FIG. 1 comprises several submodules, respectively valve positioners with pneumatic output. These submodules can be seen as force amplifiers. However, this state-of-the-art arrangement leads to a complex and bulky assembly.

As mentioned before, in order to operate high pneumatic pressures with low electrical power, a close to equilibrium topology of the submodules is typically designed, in which the forces originated by the pneumatic pressure are balanced by, e.g., counter springs. By this, only a small force and corresponding energy can be sufficient to change a position of the process valve 120. The usage of a pilot stage 116 in general leads to a bulky assembly of a system of valve positioners with pneumatic output 100 and is cost intensive. A further disadvantage of using a pilot stage 116 is that a constant blow-off of the pneumatic medium is required, which makes the system inefficient.

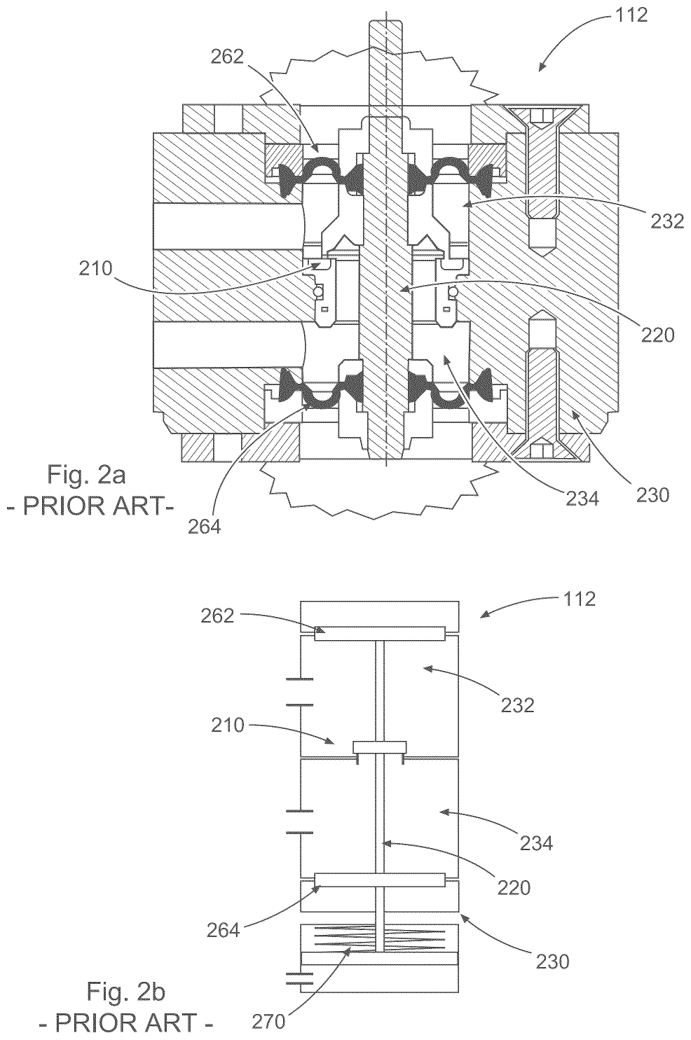

FIG. 2a sketches a state-of-the-art valve positioner with pneumatic output of a main stage 112, that means a part of the main stage 112, including a valve 210 a plunger of the valve 220 mechanically coupled to the valve 210, the first valve compartment 232 and a second valve compartment 234, which can be pneumatically coupled by the valve 210 and a first sealing diaphragm 262, which seals the first compartment 262 in respect to an outside of the valve positioner with pneumatic output as well as a second sealing diaphragm 264, configured to seal the second compartment of the valve positioner with pneumatic output to the outside of the valve positioner with pneumatic output. The first and the second sealing diaphragms 262, 264 are mounted in a housing of the valve positioner with pneumatic output and are coupled to the plunger 220 of the valve.

FIG. 2b sketches schematically the state of the art valve positioner with pneumatic output of the main stage 112 as described with FIG. 2a, where the reference signs are corresponding to the description of the FIG. 2a, to explain the functionality of a compensation element 270 of a state of the art balanced valve design, wherein the compensation element 270 is coupled to the plunger 220 of the valve to compensate forces acting on the valve 210 based on a pressure of the pneumatic fluid within the first chamber 232 of the valve positioner with pneumatic output unit and/or the second chamber 234. Using other words, the compensation element 270 is configured and arranged to reduce the force necessary to open and/or close the valve 210.

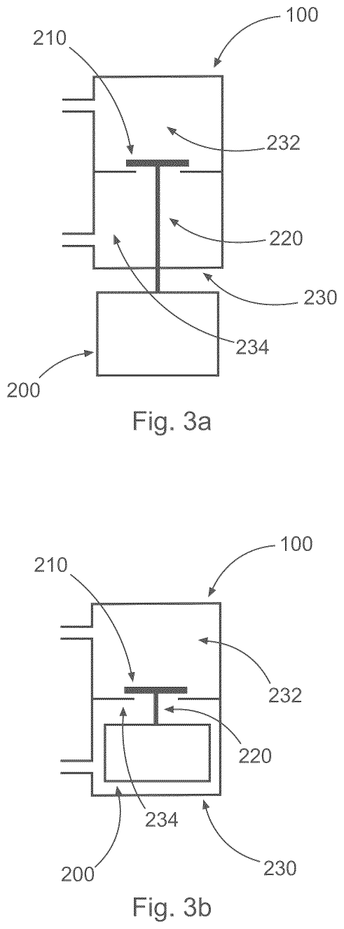

FIG. 3a sketches schematically an external positioner drive 200 for controlling a valve positioner with pneumatic output 100, respectively a unit of a valve positioner with pneumatic output 100, wherein the positioner drive 200 is configured to be mechanically coupled to a valve 210 of the valve positioner with pneumatic output 100 for controlling the valve positioner with pneumatic output 100. The positioner drive 200 can be configured to be mechanically coupled directly to a plunger 220 of the valve 210 of the valve positioner with pneumatic output 100. The positioner drive 200 as shown in FIG. 3a is configured to be arranged outside of a housing 230 of the valve positioner with pneumatic output 100.

The valve positioner with pneumatic output 100 with the positioner drive 200 as shown in FIG. 3b has an equivalent functionality to the valve positioner with pneumatic output 100 as shown in FIG. 3a, but this positioner drive 200 is configured and arranged inside of the housing 230 of the valve positioner with pneumatic output 100.

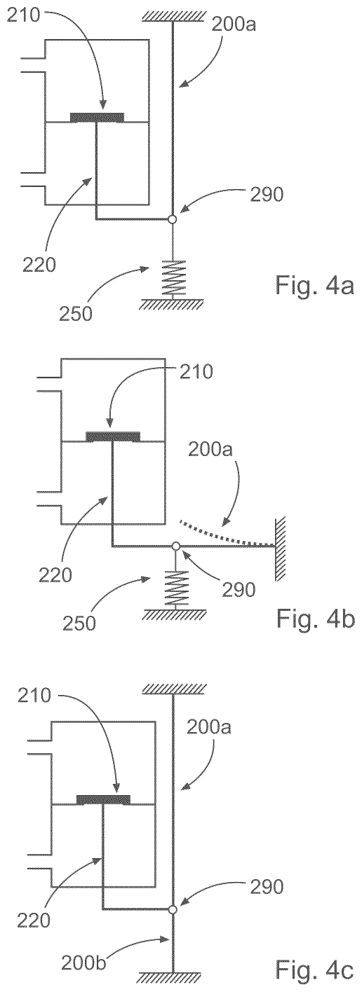

FIGS. 4a, 4b, and 4c sketch schematic drawings a valve positioner with pneumatic output 100, respectively a unit of a valve positioner with pneumatic output 100, with a positioner drive 200, wherein the positioner drive 200 includes a shape memory alloy actuation element 200a. The shape memory alloy actuation element 200a is coupled at one site of the shape memory alloy actuation element 200a to a rigid means and at the other site of the shape memory alloy actuation element 200a to the valve position with pneumatic output 100 via a coupling point 290 to control the valve 210 of the valve positioner with pneumatic output 100.

The shape memory alloy actuation element of the positioner drive 200 can be electrically coupled by electrical coupling means for providing electrical signals to the shape memory alloy actuation element 200a for operating, wherein the electrical coupling means are not shown in FIG. 4. When electrical voltage is applied to the shape memory alloy actuation element 200a, electric current flows through the shape memory alloy actuation element 200a and the shape memory alloy actuation element 200a is heated and starts contracting and providing the motion.

The position drive 200 can further comprise a resetting element to provide a bias force to the shape memory alloy actuation element 200a so that the shape memory alloy actuation element 200a can be configured to return from an elongation status to its original shape. The resetting element can be arranged to couple at one site of the resetting element to the shape memory alloy actuation element 200a at the coupling point 290 and at the other site of the resetting element to a rigid structure.

The shape memory alloy actuation element 200a illustrated in FIG. 4a comprises a SMA wire providing linear motion. The positioner diver 200 in FIG. 4a further comprises a passive reset spring 250 as the resetting element. The resetting spring 250 keeps the valve 210 of the valve positioner with pneumatic output 100 in a desired position, which can be normally open or normally closed, depending on the direction of force provided by the resetting spring. When a control voltage is applied onto the SMA wire, the shape memory alloy actuation element 200a contracts and thereby open or closes the valve 210 of the valve positioner with pneumatic output 100.

The control voltage can be arrange to provide a maximum contract of the shape memory alloy actuation element 200a leading to a maximum open or close of the valve 210 of the valve positioner with pneumatic output 100. Accordingly, simple bi-stable ON/OFF control of the valve is achieved. The control voltage can also be configured to control the contract of the shape memory alloy actuation element 200a so that the valve 210 of the valve positioner with pneumatic output 100 is opened or closed at discrete positions between its maximum opening and maximum closing.

To adjust the shape memory alloy actuation element 200a to the required forces and strokes of the different valves, the SMA wire can be realized by a single straight wire, or several straight wires in parallel. The SMA wire can also be arranged in loops or meander forms so that the SMA wire is adapted to a given design space requirements.

The shape memory alloy actuation element 200a illustrated in FIG. 4b comprises a SMA rod or a SMA sheet providing rotational motion. The resetting element of the positioner driver comprises a passive reset spring 250 keeping the valve 210 of the valve positioner with pneumatic output 100 in a desired position. Depending on the direction of force provided by the resetting spring, the valve 210 is kept normally open or normally closed. When a control voltage is applied onto the SMA rod/sheet, the shape memory alloy actuation element 200a deflects and thereby opens or closes the valve 210 of the valve positioner with pneumatic output 100.

Similar as the positioner diver 200 in FIG. 4a, the SMA rod/sheet is arranged to provide bi-stable ON/OFF of the valve 210 or to open/close the valve in a controlled manner between its maximum opening and maximum closing according to the control voltages applied on the SMA rod/sheet.

FIG. 4c illustrates a positioner diver 200 comprising a first shape memory alloy actuation element 200a and a second shape memory alloy actuation element 200b. The first and the second shape memory alloy actuation elements are coupled at the coupling point 290. The shape memory alloy actuation element 200b of the positioner drive 200 can be electrically coupled by electrical coupling means for providing electrical signals to the shape memory alloy actuation element 200b so as to form an agonist-antagonistic topology with the first shape memory alloy actuation element 200a. In other words, the first shape memory alloy actuation element 200a is configured in a contraction status while the second shape memory alloy actuation element 200b is configured in an elongation status, and vice versa. Accordingly, one shape memory alloy actuation element acts as a resetting element of the other.

Unlike the positioner driver illustrated in FIG. 4a or 4b, the positioner diver in FIG. 4c does not provide normally open or normally closed position of the valve 210 of the valve positioner with pneumatic output 100. Instead, it has a so-called fail freeze function which keeps the valve 210 staying at the last position on the loss of the electrical power supply.

Similar as the position driver illustrated in FIG. 4a or 4b, the positioner driver comprising two antagonistic SMA elements 200a, 200b acting in opposite directions can also provide bi-stable ON/OFF control of the valve 210 of the valve positioner with pneumatic output 100 or open/close the valve 210 in a controlled manner between its maximum opening and maximum closing according to the control voltages applied on the shape memory alloy actuation element.

The shape memory alloy actuation elements in FIG. 4c are illustrated as SMA wires as described above. However, they can also be realized by SMA rods, sheet metal or springs.

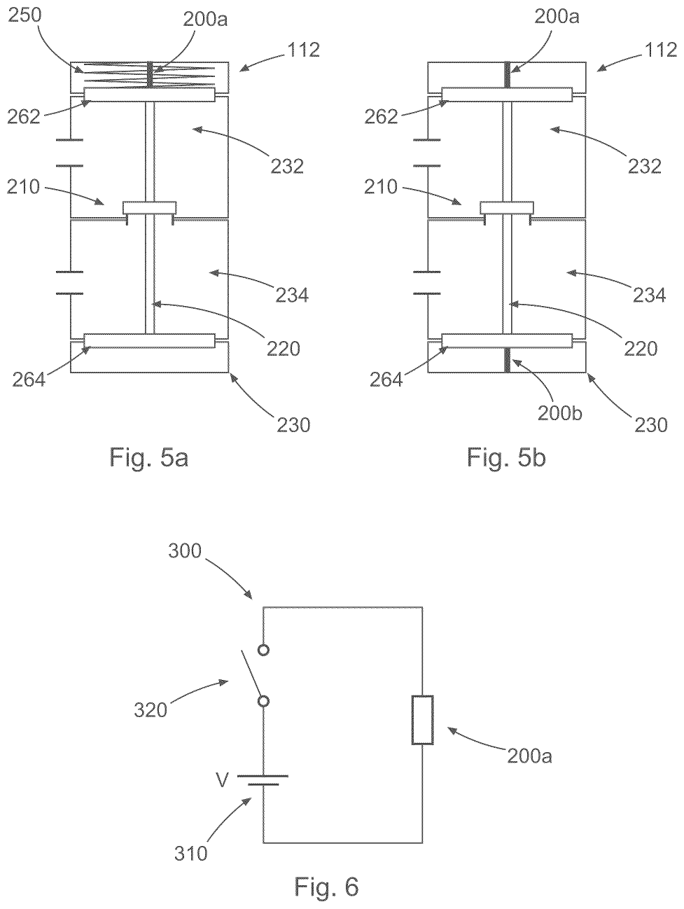

FIGS. 5a and 5b sketch schematic drawings a valve positioner with pneumatic output 100, respectively a unit of a valve positioner with pneumatic output 100, including a positioner drive 200, wherein the positioner drive 200 can include a shape memory alloy actuation element 200a. The shape memory alloy actuation element 200a is coupled at one site of the shape memory alloy actuation element 200a to a rigid means, for instance a housing of the valve positioner with pneumatic output 100 and at the other site of the shape memory alloy actuation element 200a to a plunger 220 of the valve of the valve positioner with pneumatic output 100 to control the valve 210 of the valve positioner with pneumatic output 100.

The shape memory alloy actuation element of the positioner drive 200 can be electrically coupled by electrical coupling means for providing electrical signals to the a shape memory alloy actuation element 200a for operating, wherein the electrical coupling means are not shown in FIG. 5. When electrical voltage is applied to the shape memory alloy actuation element 200a, electric current flows through the shape memory alloy actuation element 200a and the shape memory alloy actuation element 200a is heated and starts contracting and providing the motion. The position drive 200 can further comprise a resetting element to provide a bias force to the shape memory alloy actuation element 200a so that the shape memory alloy actuation element 200a can be configured to return from an elongation status to its original shape.

The resetting element in FIG. 5a comprises a passive reset spring 250, which is mechanically coupled with the plunger 220 of the valve of the valve positioner with pneumatic output 100. The resetting element 250 as illustrated in FIG. 5a can be arranged at the end of plunger 220 same as the shape memory alloy actuation element 200a. The resetting element 250 can alternative be arranged at the opposite end of plunger 220 to provide a bias force, which is not show in the figure.

The resetting element in FIG. 5b comprises a second shape memory alloy actuation element 200b which is coupled to the opposite end of the plunger 220 of the valve of the valve positioner with pneumatic output 100. The second shape memory alloy actuation element 200b of the positioner drive 200 can be electrically coupled by electrical coupling means for providing electrical signals to the shape memory alloy actuation element 200b so as to form an agonist-antagonistic topology with the first shape memory alloy actuation element 200a. In other words, the first shape memory alloy actuation element 200a is configured in a contraction status while the second shape memory alloy actuation element 200b is configured in an elongation status, and vice versa.

The resetting element comprising a second shape memory alloy actuation element 200b can alternatively be arranged at the end of the plunger 220 same as the first shape memory alloy actuation element 200a so that two shape memory alloy actuation elements are connect in series and one site of the shape memory alloy actuation element is coupled to a rigid means, for instance a housing of the valve positioner with pneumatic output 100 and one site of the other shape memory alloy actuation element is coupled to the plunger 220 of the valve of the valve positioner with pneumatic output 100.

The resetting element described above comprises a resetting spring 250 or a shape memory alloy actuation element 200b. It can also be configured as means for providing weight force so as to provide a bias force.

The shape memory alloy actuation elements described above can comprise a thermal shape memory alloy wire, rod, sheet metal or a spring. Accordingly, the maximum stroke and force provided by the shape memory alloy actuation element 200a as well as the time response can be configured in terms of the dimension of the cross-section of the SMA material or the length of the SMA material so as to fit the design requirements of the shape memory alloy actuation element.

FIG. 6 sketches schematic drawing of a positioner drive 200 including a shape memory alloy actuation element. FIG. 6 sketches a system 300 of a voltage source 310 which is configured using a switch 320 to be connected to the shape memory alloy actuation element 200a, such that the shape memory alloy actuation element 200a will contract because of the electric current and by this can control, e.g., a valve 210 of a valve positioner with pneumatic output 100. The voltage source 310 output a defined voltage, e.g. 6V, 12V, or 24V so that the temperature of the shape memory alloy actuation element 200a or 200b can be controlled. In case the valve 210 is opened/closed in a controlled manner at discrete positions between its maximum opening and maximum closing, an additional information related to the position of the valve 210 is feedback to the system 300. The additional information may be the position of the valve 210 or the contract status of the shape memory alloy actuation element 200a.

Similarly, system 300 can be applied to the second shape memory alloy actuation element 200b when positioner driver 200 comprises antagonistic thermal shape memory alloy actuation elements.

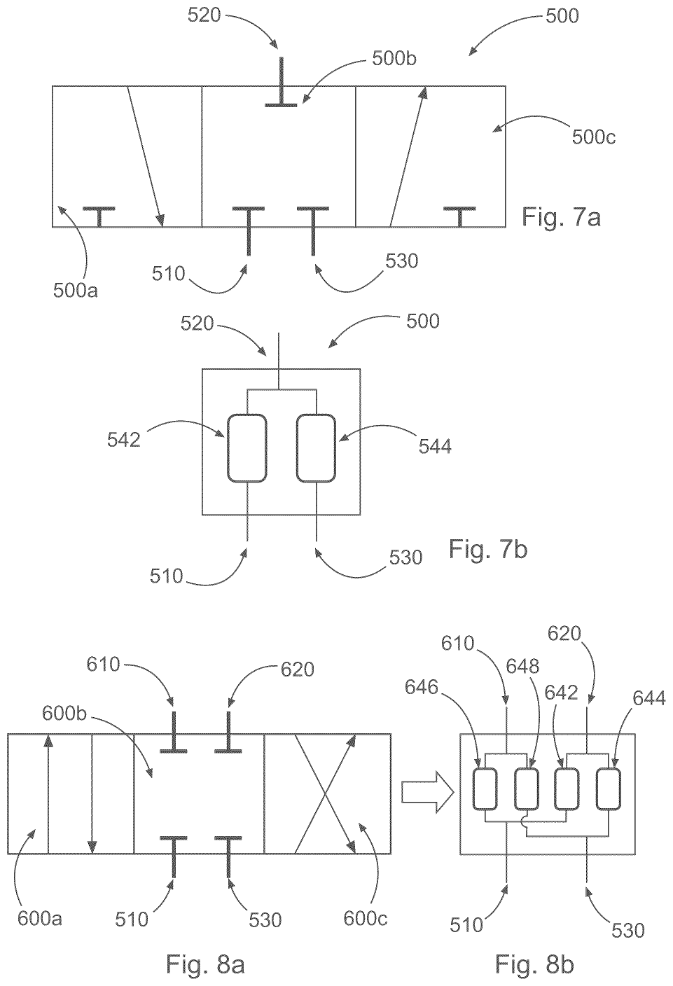

FIG. 7a sketches schematically a 3/3 direction positioner valve 500, respectively a system of valve positioners with pneumatic output 500, including a twin on/off valve topology. The functionality of the 3/3 direction positioner valve 500 is schematically indicated by a de-aerate position 500a, a block position 500b and an aerate position 500c as indicated in FIG. 5a. Such a 3/3 direction positioner valve can include an inlet port 510, an outlet port 520 and a ventilation port 530 to provide the mentioned functionality.

FIG. 7b sketches schematically a block diagram of the 3/3 direction positioner valve 500 including a twin on/off valve topology, including two valve positioner with pneumatic output 542, 544, which are pneumatically coupled at an outlet side of the valve positioner with pneumatic output 542, 544, which is pneumatically coupled to the outlet port 520 of the system of valve positioners with pneumatic output 500. An inlet port of the first positioner 542 is pneumatically connected to the inlet 510 of the system of valve positioners with pneumatic output 500 and an inlet port of the second positioner 544 is pneumatically connected to a ventilation port 530 of the system of valve positioners with pneumatic output 500.

The following operation matrix indicates a position of the first positioner unit V1 542 and the second positioner unit V2 544 to provide the functionality as described above:

| | V1 | V2 |
|---|---|---|
| Aerate | 1 | 0 |
| De-aerate | 0 | 1 |
| Blocked | 0 | 0 |
| “Flushing” | 1 | 1 |

FIG. 8a sketches schematically a 4/3 direction positioner valve 600, respectively a system of valve positioners with pneumatic output 500, including a quattro on/off valve topology. The functionality of the 4/3 direction positioner valve 600 is schematically indicated by an open position 600a, a block position 600b and a closed position 600c as indicated in FIG. 8a. Such a 4/3 direction positioner valve 600 can include an inlet port 510, a first outlet port 610, a second outlet port 620 and a ventilation port 530 to provide the described functionality.

FIG. 8b sketches schematically a block diagram of the 4/3 direction positioner valve 600 including a quattro on/off valve topology, having four valve positioners with pneumatic output 642, 644, 646, 648, wherein the first valve positioner with pneumatic output 642 and the second positioner 644 are pneumatically coupled at an outlet side of the first and the second valve positioner with pneumatic output 642, 644, which is pneumatically coupled to the second outlet port 620 of the system of valve positioner with pneumatic output 600. An inlet port of the first positioner 642 is pneumatically connected to the inlet port of a third valve positioner with pneumatic output 646, such that both are pneumatically connected to a first inlet port 510 of the valve positioner with pneumatic output 600. An inlet port of a second positioner unit 644 is pneumatically connected to an inlet port of a fourth valve positioner with pneumatic output unit 648, such that both are pneumatically connected to a second inlet port 530 of the system of valve positioner with pneumatic output 600.

The following operation matrix indicates a position of the first positioner unit V1 642, the second positioner unit V2 644, the third positioner unit V3 646 and the fourth positioner unit V4 648 to provide the functionality as described above:

| | V1 | V2 | V3 | V4 |
|---|---|---|---|---|
| OPEN | 1 | 0 | 0 | 1 |
| CLOSED | 0 | 1 | 1 | 0 |
| Blocked | 0 | 0 | 0 | 0 |
| | 1 | 1 | 1 | 1 |
| | 1 | 1 | 1 | 0 |
| | 1 | 1 | 0 | 0 |
| | 1 | 1 | 0 | 1 |
| | 1 | 0 | 0 | 0 |
| | 1 | 0 | 1 | 1 |
| | 1 | 0 | 1 | 0 |
| | 0 | 1 | 1 | 1 |
| | 0 | 0 | 0 | 1 |
| | 0 | 1 | 0 | 0 |
| | 0 | 1 | 0 | 1 |
| | 0 | 0 | 1 | 1 |
| | 0 | 0 | 1 | 1 |
| | 0 | 0 | 1 | 0 |

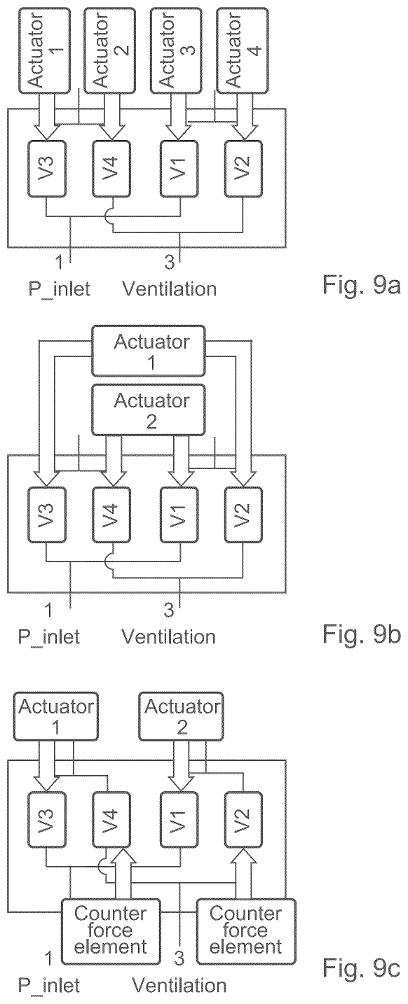

FIG. 9a-9c sketch schematically different actuation strategies of the above described 4/3 direction positioner valve 600 controlling a pneumatic actuator 110 operated in the way of double actuation. More specifically, FIG. 9a illustrates a system of valve positioners with pneumatic output comprising four positioner drives 200 as actuator 1 to 4 actuate the four valve positioners respectively.

FIG. 9b illustrates a system of valve positioners with pneumatic output comprising two positioner drives 200 as actuator 1 and actuator 2 for controlling all four valve positioners. Actuator 1 controls the second and third valve positioners and actuator 2 controls the first and fourth valve positioners. As shown in FIG. 9b, each actuator controls the two valve positioners. The two valves of the positioners are mechanically coupled, for example by a passive element such as a spring to provide a sequential opening or closing of the combined valves.

FIG. 9c illustrates a system of valve positioners with pneumatic output comprising two positioner drives 200 as actuator 1 and actuator 2 and two counter force elements. As shown in FIG. 9c, actuators 1 and 2 control the third and first valve positioners respective and the counter force elements are coupled to the second and fourth valve positioners for ventilation.

It should be noted that embodiments of the invention are described with reference to different subject-matter. In particular, some embodiments are described with reference to method-type features, whereas other embodiments are described with respect to apparatus-type features. A person skilled in the art will gather from the above description, that, unless otherwise notified, in addition to any combination of features belonging to one type of subject-matter, also any combination between features relating to different subject-matter is considered to be disclosed within this application.

It should be noted that the term “comprising” does not exclude other elements or steps, and the indefinite article “a” or “an” does not exclude a plurality. Let it further be noted that features described with reference to one of the above embodiments can also be used in combination with other features of other embodiments described above. Moreover, while at least one embodiment has been presented in the foregoing summary and detailed description, it should be appreciated that a vast number of variations exist. It should also be appreciated that the embodiment or embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an embodiment without departing from the scope as set forth in the appended claims and their legal equivalents. Any reference signs in the claims should not be construed as limiting the scope of the claims.

Aspects of the present invention are related to a shape memory alloy (SMA) actuation element, also named “SMA actuator” for controlling a valve positioner with pneumatic output, a valve positioner with pneumatic output, a system of valve positioners with pneumatic output, and a use of a positioner drive.

In this entire description of the invention, the sequence of procedural steps is presented in such a way that the process is easily comprehensible. However, the skilled person will recognize that many of the process steps can also be executed in a different order and lead to the same or a corresponding result. In this sense, the sequence of the process steps can be changed accordingly. Some features are provided with counting words to improve readability or to make the assignment more clear, but this does not imply the presence of certain features.

To achieve these and other advantages and in accordance with the purpose of the invention, as embodied and broadly described herein, there is provided a positioner drive for controlling a pneumatic positioner, including shape memory alloy actuation element, wherein the shape memory alloy actuation element is configured to be mechanically coupled to a valve of the valve positioner with pneumatic output for controlling the pneumatic positioner.

A valve positioner with pneumatic output can be a device which is configured to control a pneumatic actuator. The valve positioner with pneumatic output can include a single or a plurality of valve positioners with pneumatic output that is/are configured to control a pneumatic actuator. The pneumatic actuator can be mechanically coupled to a process valve to control the process valve.

The shape memory alloy actuation element can be configured to be controlled by electric current and/or the shape memory alloy actuation element can be configured to be coupled to the valve of the valve positioner with pneumatic output.

Using other words, by using such a positioner drive the pneumatic positioner, or units of a main stage of the system of valve positioners with pneumatic output, is/are driven and/or operated directly by the positioner drive to make a pilot stage and/or a pressure reducer obsolete to save energy and/or to have a less bulky system of valve positioners with pneumatic output. That means the valve positioner with pneumatic output can be designed to have a reduced design space, as compared to systems of valve positioners with pneumatic output as is state-of-the-art.

This direct actuation by a positioner drive, not using pneumatic pressure to operate units of the main stage, can be controlled by electrical signals and/or electrical power provided to the positioner drive.

Advantageously the pneumatic positioner, which is mechanically coupled to a positioner drive can provide a robust system, because it can be built by a less complex mechanical construction. In addition, such a valve positioner with pneumatic output can be configured to be more robust towards temperature changes and external vibrations than a pneumatic pilot stage and by this it can be adapted to a plurality of production environments. To drive the valve positioner with pneumatic output directly reduces the requirements in respect to a quality of the air of the overall pneumatic system, because it is less sensitive to particles distributed by the air, which may get stuck within, e.g., a pneumatic pilot stage.

A discrete operation of the individual valves of the valve positioner with pneumatic output system by the corresponding positioner drives can improve the performance of the valve positioner with pneumatic output system. Because there is no steady state air flow necessary for a pilot stage this steady-state air consumption is eliminated.

Advantageously only minor changes may have to be designed to modify existing positioner drives to include a shape memory alloy actuation element, thereby existing designs, which can be configured for high flow rates and high pressures with a customer proven technology, can be used, as key valve components, for the proposed positioner drives, which include the shape memory alloy actuation element.

According to an aspect, the shape memory alloy actuation element is configured to be mechanically coupled the valve of the pneumatic positioner. This direct mechanically coupling with the valve enables to set up a simple system using such valve positioner with pneumatic output including a positioner drive, which can be driven directly by electrical signals provided to the shape memory alloy actuation element.

According to an aspect, the shape memory alloy actuation element is based on thermal shape memory alloy; and two electrical electrodes are provided adjacent to the shape memory alloy actuation element at the opposite ends to control the shape memory alloy actuation element based on an electric current provided to the electrical electrodes.

Thermal shape memory alloy actuators are members of the group of “non-conventional actuators”, which are based on smart materials. The basic principal is based on temperature dependent phase transformation of the crystal structure, which leads to a macroscopic shortening of the material. To control the shortening, the temperature must be controlled, which can be done by applying an electrical voltage. The electrical resistance of the SMA material will then lead to a temperature increase. Advantageously shape memory alloy actuators have a proven track record in various applications and can be adapted for the described purpose as described.

According to an aspect, electrical counter electrodes are provided adjacent to the shape memory alloy actuation element at the opposite ends of the shape memory alloy actuation element as the electrical electrodes for generating an electric current between the electrodes when electrical voltage is applied.

According to an aspect, the shape memory alloy actuation element includes: a first electrical contact electrically coupled to a first electrical electrode of the shape memory alloy actuation element; and a second electrical contact electrically coupled to a second electrical electrode of the shape memory alloy actuation element; and the first and second electrical contacts are configured for provision of electrical voltage to operate the shape memory alloy actuation element.

According to an aspect, the shape memory alloy actuation element is configured to be in a contraction status when the electrical voltage is provided to the electrical electrodes and in an elongation status otherwise.

The shape memory alloy actuation element changes from a contraction status to an elongation status or wise verse so that a motion is provided.

According to an aspect, the shape memory alloy actuation element is operated by an electrical voltage in a maximum contraction status providing a maximum opening or closing of a valve of a valve positioner with pneumatic output.

The maximum contract status operated by the electrical voltage provides bi-stable ON/OFF control of the valve of a valve positioner with pneumatic output.

According to an aspect, the shape memory alloy actuation element is further operated by an electrical voltage in a contraction status within its maximum contraction so as to provide an opening or closing of a valve of a valve positioner with pneumatic output at a position between its maximum opening and maximum closing.

The shape memory alloy actuation element operated in a contraction status within its maximum contraction is able to control a valve of a valve positioner with pneumatic output to open or close at discrete positions between its maximum opening and closing.

According to an aspect, the shape memory alloy actuation element is configured to be arranged within a housing of the pneumatic positioner.

Building of a pneumatic positioner, wherein the positioner drive is inside of the housing of the valve positioner with pneumatic output enables a compact design of the pneumatic positioner.

According to an aspect, the shape memory alloy actuation element is configured to be mechanically coupled to a housing of the valve positioner with pneumatic output for controlling the pneumatic positioner.

The shape memory alloy actuation element can be coupled to the housing of the valve positioner with pneumatic output for enabling the movement of the valve of the pneumatic positioner by the motion generated by the shape memory alloy actuation element.

According to an aspect, the shape memory alloy actuation element is configured to be arranged outside of the housing of the pneumatic positioner.

If the shape memory alloy actuation element is arranged outside of the housing of the pneumatic positioner, advantageously designed changes of the valve positioner with pneumatic output are minimized and access to the shape memory alloy actuation element, e.g. for maintenance, can be easily provided.

According to an aspect, the shape memory alloy actuation element comprises a spring, rod, wire or sheet metal made of an alloy that shows the thermal shape memory effect.

Variety of choices can be selected from half-finished products such as (helical) spring, rod, wire or sheet metal, thereby fitting the design requirements of the shape memory alloy actuation element.

According to an aspect, the positioner drive further comprises a resetting element and the resetting element comprises a passive reset spring, and/or means for providing weight force, and/or a second actuation element which is configured to provide a bias force to the shape memory alloy actuation element. Accordingly, the shape memory alloy actuation element can return to its elongation status.

According to an aspect, the resetting element comprises a second shape memory alloy actuation element forming an agonist-antagonistic topology with the first actuation element based on SMA.

The resetting element can include a second shape memory alloy actuation element, which is mechanically coupled to the first shape memory alloy actuation element. The two shape memory alloy actuation elements can be configured to be always in different status so as to form an agonist-antagonistic topology.

According to an aspect, a valve positioner with pneumatic output is provided, that includes a positioner drive as described above.

According to an aspect, a valve positioner with pneumatic output system is provided, which includes a plurality of pneumatic positioners as described above; and a plurality of positioner drives as described above, which are configured to control the plurality of pneumatic positioners.

According to an aspect, the plurality of pneumatic positioners and the plurality of positioner drives of the valve positioner with pneumatic output system are configured to provide the functionality of a 3/3 positioner valve system or 4/3 positioner valve system.

Pneumatic positioners, respectively systems of valve positioners with pneumatic output, including “3/3 valve functionality” or “4/3 valve functionality” are a demand from the industry. The term “3/3” means a system of valve positioners with pneumatic output including “3” pneumatic ports: a pressure inlet; an output port; and a ventilation port and including “3” possible operation modes: forward; backward; and blocked movement of the pneumatic actuator. The term means a system of valve positioners with pneumatic output including “4” pneumatic ports: a pressure inlet; a first and a second output port; and a ventilation port including “3” possible operation modes: forward; backward; and blocked movement of the pneumatic actuator. In general, different main stage topologies for the system of valve positioners with pneumatic output exist to allow for a 3/3 valve functionality or 4/3 valve functionality. That means using the valve positioner with pneumatic output as described provide for building the system of valve positioners with pneumatic output 3/3 or 4/3 functionality provides advantageously a modular setup for a required functionality and an assembly of the system of valve positioner with pneumatic output.

Each of the pneumatic positioners of the system of valve positioners with pneumatic output can be operated directly by a positioner drive as described. An actuation of the positioner drive can additionally or alternatively be based on different physical principals like pneumatics, hydraulics, electricity, etc.

A use of a positioner drive as described above is proposed, to control a valve positioner with pneumatic output and/or a valve positioner with pneumatic output system and/or a pneumatic actuator for controlling a process valve.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A positioner drive for controlling a valve positioner with pneumatic output, comprising:
a shape memory alloy actuation element,
wherein the shape memory alloy (SMA) actuation element is configured to be mechanically coupled to a valve of the valve positioner with pneumatic output for controlling the valve positioner with pneumatic output.

2. The positioner drive according to claim 1, wherein the shape memory alloy actuation element (200a) is based on thermal shape memory alloy; and wherein two electrical electrodes are provided adjacent to the shape memory alloy actuation element at the opposite ends to control the shape memory alloy actuation element based on an electrical voltage provided to the electrical electrodes.

3. The positioner drive according to claim 1, wherein the shape memory alloy actuation element comprises:
a first electrical contact electrically coupled to a first electrical electrode of the shape memory alloy actuation element; and
a second electrical contact electrically coupled to a second electrical electrode of the shape memory alloy actuation element;
wherein the first and second electrical contacts are configured for provision of electrical voltage to operate the shape memory alloy actuation element.

4. The positioner drive according to claim 1, wherein the shape memory alloy actuation element is in a contraction status when an electrical voltage is provided to the electrical electrodes and in an elongation status otherwise.

5. The positioner drive according to claim 1, wherein the shape memory alloy actuation element is operated by an electrical voltage in a maximum contraction status providing a maximum opening or closing of a valve of a valve positioner with pneumatic output.

6. The positioner drive according to claim 1, wherein the shape memory alloy actuation element is further operated by an electrical voltage in a contraction status within its maximum contraction so as to provide an opening or closing of a valve of a valve positioner with pneumatic output at a position between its maximum opening and maximum closing.

7. The positioner drive according to claim 1, wherein the shape memory alloy actuation element is configured to be arranged within a housing of the valve positioner with pneumatic output.

8. The positioner drive according to claim 1, wherein the shape memory alloy actuation element is configured to be arranged outside of a housing of the valve positioner with pneumatic output.

9. The positioner drive according to claim 1, wherein the shape memory alloy actuation element comprises a spring, rod, wire or sheet metal made of an alloy that shows the thermal shape memory effect.

10. The positioner drive according to claim 1, further comprising a resetting element, wherein the resetting element comprises a passive reset spring, and/or structures for providing weight force, and/or a second actuation element which is configured to provide a bias force to the shape memory alloy actuation element.

11. The positioner drive according to claim 10, wherein the resetting element comprises a second shape memory alloy actuation element forming an agonist-antagonistic topology with the first actuation element based on SMA.

12. A valve positioner with pneumatic output, comprising a positioner drive according to claim 1.

13. A system of valve positioners with pneumatic output in process industries, comprising a plurality of pneumatic positioners according to claim 12; and a plurality of positioner drives configured to control the plurality of pneumatic positioners.

14. The system of valve positioners with pneumatic output according to claim 13, wherein the plurality of pneumatic positioners and the plurality of positioner drives is configured to provide the functionality of a 3/3 positioner valve system or 4/3 positioner valve system.
